(19) United States
(12) Patent Application Publication
(10) Pub. No.: US 2014/0122619 A1
(43) Pub. Date: May 1, 2014

(54) CHATBOT SYSTEM AND METHOD WITH INTERACTIVE CHAT LOG

(71) Applicant: Xiaojiang Duan, Chaoyang District (CN)

(72) Inventor: Xiaojiang Duan, Chaoyang District (CN)

(21) Appl. No.: 13/661,045

(22) Filed: Oct. 26, 2012

(51) Int. Cl. G06F 15/16

(52) U.S. Cl. 709/206

(57) ABSTRACT

A chatbot system and method with interactive chat log. A chatbot includes a processor, an interactive dialog interface and said knowledge database. The chatbot generates a chat log page including messages based on a chat session. Without leaving the chat log page, the chatbot uses the chat log page for updating chatbot messages and corresponding entries in a knowledge database.

### CROSS-REFERENCE TO RELATED APPLICATIONS

This application is related to the following U.S. non-provisional patent applications: U.S. patent application Ser. No. ______, entitled “User-Aided Learning Chatbot System and Method” filed herewith (Attorney Docket No. ACOSYS.002US); U.S. patent application Ser. No. ______, entitled “Chatbot System and Method with Contextual Input and Output Messages” filed herewith (Attorney Docket No. ACOSYS.003US); U.S. patent application Ser. No. ______, entitled “Chatbot System and Method with Enhanced User Communication” filed herewith (Attorney Docket No. ACOSYS.004US); U.S. patent application Ser. No. ______, entitled “Chabot System and Method Having Auto-Select Input Message with Quality Response” filed herewith (Attorney Docket No. ACOSYS.006US); all of which are hereby incorporated by reference in their entirety as if fully set forth in the present invention for all purposes.

### COMPUTER PROGRAM LISTING APPENDIX

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to chatbot systems and methods and more specifically to chatbot systems and methods for facilitating user training of chatbots.

Chatbot computer programs are designed to simulate intelligent conversation with one or more human users via auditory or textual methods. Chatbots are often integrated into interactive dialogs for various practical purposes such as personalized service or information acquisition.

The answers received from the chatbot during a chat session between the user and the chatbot are often preprogrammed into the chatbot. Input messages from users and output messages from the chatbot are typically paired, sometimes with a context entry, in a knowledge database. For example, an input/output message pair might be:

User: Are you a female bot?

Chatbot: Yes. Are you a girl?

The more comprehensive the knowledge database is, the more proficient the chatbot is. Thus, many chatbot systems typically include a chat log that records conversations between users and chatbots during chat sessions to determine which input/output message pairs based on the conversation can be added to update the knowledge database.

Traditionally, the administrator begins the updating process by displaying the chat log on screen for review. Here, the administrator might review the chat log until a new message pair that can be incorporated in the knowledge database is found. After a new message pair is found, the administrator typically exits the chat log interface to access a database interface to enter the new message pair to the knowledge database.

After the message pair is entered, the administrator then returns to the chat log interface to find additional message pairs that can be added to the knowledge database. Upon finding another message pair, the administrator then re-accesses the knowledge database interface to enter the additional message pair.

This back and forth process continues, until all new message entries from the chat log are entered into the knowledge database. Consequently, when there are fewer message pairs for entry, the message entry task is relatively quick. When there numerous new message pairs to be entered, the administrator can become fatigued or might require considerable amounts of time to complete the knowledge entry task.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a chatbot system and method with interactive chat log can be found in exemplary embodiments of the present invention.

In a first embodiment, a method for updating chatbot messages and corresponding knowledge entries in a knowledge database is disclosed. The chatbot receives a plurality of input messages from a user and generates a plurality of output messages responsive to the plurality of input messages.

In one embodiment, the method displays a chat log page when so requested by the user. The chat log page might include input messages from a user as well as chatbot output messages responding to such input messages. The chat log page is such that the chatbot messages are configured to be selectable by user.

As an example, an edit link may be disposed adjacent to each corresponding chatbot message, said edit link being selectable to modify the corresponding chatbot message. Among other advantages, in one embodiment, messages can be modified using the chat log page without having to leave the chat log page. Thus, unlike conventional systems, administrators can utilize the chat log page to update messages without have to switch back and forth between a chat log page and a database interface during knowledge entries.

When a selected chatbot message is replaced with new message, the selected chatbot message may be crossed out for display to the user on the chat log page. In this manner, the user is aware of that the new output message is the current response for a corresponding chatbot input message.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a chatbot communication system according to an exemplary embodiment of the present invention.

FIG. 2 illustrates a chatbot dialog interface of the chatbot system of FIG. 1 in accordance with an exemplary embodiment of the present invention.

FIG. 3A illustrates a chat log interface according to an exemplary embodiment of the present invention.

FIG. 3B illustrates a chat log interface according to an exemplary embodiment of the present invention.

FIG. 3C illustrates a chat log interface according to an exemplary embodiment of the present invention.

FIG. 4 illustrates a better reply method for creating or updating a script in accordance with an exemplary embodiment of the present invention.

FIG. 5 illustrates a script interface “Are all plans free?” in accordance with an exemplary embodiment of the present invention.

FIG. 6A shows a typical computer such as would be operated by a user on the Internet and suitably programmed using one or more lines of code to execute embodiments of the present invention.

FIG. 6B shows subsystems of the computer of FIG. 6A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

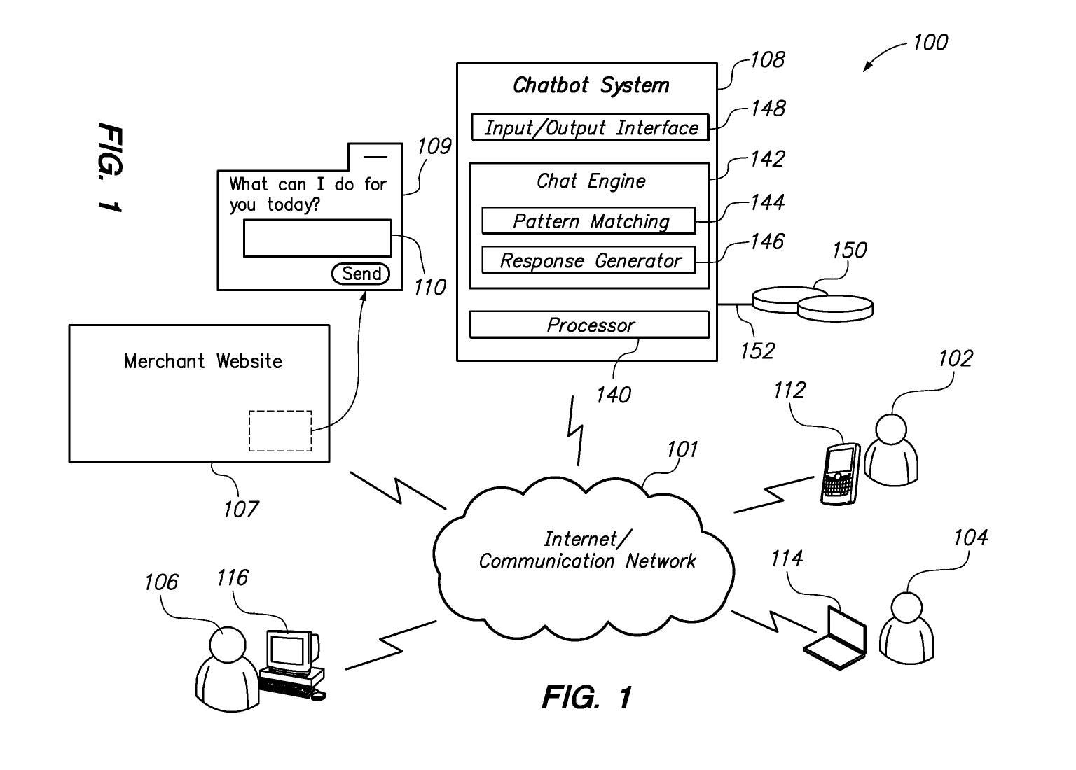

FIG. 1 illustrates chatbot communication system 100 according to an exemplary embodiment of the present invention.

In FIG. 1, chatbot communication system 100 comprises user 102 communicably coupled to chatbot system 108 via Internet 101. User 102 represents a customer visiting a website over Internet 101, and commencing a chat session with chatbot system 108.

Internet 101 represents any distributed network (wired, wireless or otherwise) for data transmission and receipt between/among two or more points. In some embodiments, chatbot system 108 includes a graphical image, including, without limitation, an avatar, a talking head, a text-to-speech engine, etc. Although not shown, chatbot system 108 might be installed on a stand-alone computer without need for a computer network.

As shown in FIG. 1, user 102 utilizes mobile device 112 to communicate with chatbot system 108. Mobile device 112 is a portable communication device such as a smart phone and the like. In one embodiment, the communication with chatbot system 108 can occur when user 102 is visiting one or more websites such as merchant website 107 that has chatbot dialog interface 116 of chatbot system 108 preinstalled on the website as further discussed below. User 102 essentially uses a browser (not shown) and chatbot dialog interface 116 to interact with chatbot system 108.

In FIG. 1, user 104 represents an additional customer. Many customers can concurrently communicate with chatbot system 108. Here, user 104 utilizes laptop computing device 114 for communicating with chatbot system 108 in a manner akin to user 102. For example, user 104 visiting merchant website 107 can also communicate with chatbot system 108 via chatbot dialog interface 116.

In FIG. 1, merchant 106 represents a merchant that operates merchant website 107. Merchant 106 installs chatbot dialog interface 116 of chatbot system 108 on its merchant website 107. Chatbot dialog interface 116 is a client extension of chatbot system 108. Thus, users can communicate with chatbot system 108 via chatbot dialog interface 116. Consequently, users visiting merchant website 107 can learn about products and/or services offered by merchant 106 by communicating with chatbot system 108 via chatbot dialog interface 116.

Here, merchant 106 provides initial training for chatbot system 108 by using a browser (not shown) on desktop computing device 115. Specifically, merchant 106 uses the browser to access and display chatbot dialog interface 116 to communicate with chatbot system 108. In essence, merchant 106 provides the message and theme for chatbot system 108 while users 102, 104 are the corresponding consumers.

Merchant 106 can train chatbot system 108 by entering input messages into dialog box 110 of chatbot dialog interface 116. Chatbot system 108 responds to an input message by displaying an output message via output display 109 above dialog box 110. As shown, an output message “What can I do for you today?” is displayed by output display 109. Note that this is a special output message, called an initial or opening message. Its corresponding “input message” is the user's action of browsing to a web page.

Chatbot messages are generated by chatbot system 108 by querying the input message from users in a knowledge base according to a certain set of rules. Merchant 106 trains chatbot system 108 to provide modified messages for a chat session by replacing chatbot system 108's initial chatbot messages with user-generated messages.

Chatbot system 108 includes a graphical image representing chatbot dialog interface 116, the graphical image including, without limitation, an avatar, a talking head, a text-to-speech engine, etc. In some embodiments, users 102, 104, 106 enter input messages to chatbot system 108 with a keyboard, mouse, and a visual recognition device.

The back and forth interaction between chatbot system 108 and users 102, 104 and 106 via chatbot dialog interface 116 allows knowledge database 150 to store and process myriad combinations of user-generated messages as context for additional future chatbot messages.

In FIG. 1, chatbot system 108 includes input/output interface 148 for entering and displaying messages to and from users 102, 104, 106. Chatbot system 108 also includes chat engine 142 that receives an input message from dialog box 110 and processes the input message by pairing or associating the input message with an appropriate chatbot message. Note that, conveniently, one or more components of chatbot system 108 may be conveniently referred to as chatbot system 108.

Chat engine 142 utilizes pattern matching engine 144 to recognize appropriate responses for input messages. In one embodiment, pattern matching engine 144 employs AIML (Artificial Intelligence Markup Language), which is an XML dialect. Note that AIML implementation is used in one embodiment but other implementations are used as well. Here, AIML comprises several elements. A first is category, which is a fundamental unit of knowledge. A category includes two or more elements (e.g. pattern and template).

<category>

<pattern>WHAT IS YOUR NAME</pattern>
<template>My name is Eddy.</template>

</category>

When this category is loaded, a chatbot receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your *” can match many inputs such as “what is your objective,” what is your address,” etc.

A template provides the response for a pattern. An example of a template is —My name is Eddy. A template can also use variables. A template may be as simple as some literal text, like “My name is <chatbot name=“name”/>,” which substitutes the chatbot's name into the sentence, or “You said you are <get name=“userage”/> years of age,” in which the user's age is replaced in the sentence.

Text formatting, conditional response (if then/else), and random responses are elements of templates. Templates can also use the srai element to redirect to another pattern.

<category>

<pattern>What is your name</pattern>
<template>My name is <bot name=“name”></template>

</category>
<category>

<pattern>WHAT IS YOUR GIVEN NAME</pattern>

<template>

<srai>What is your name</srai>

</template>

</category>

In the first category, the input “What is your name” receives the chatbot's name as a response. In the second category, the input “WHAT IS YOUR GIVEN NAME” is redirected to the category that matches the input “What is your name.” In essence, the two phrases are equivalent. Templates may include other content types that are processed by the chatbot user interface. As an example, a template may employ HTML (Hyper-Text Markup Language) tags for formatting. Clients not supporting HTML typically ignore the tag.

Those skilled in the art will recognize that other techniques that can either substitute or supplement pattern matching engine 144 can be employed. After pattern matching engine 144 recognizes appropriate responses for input messages, pattern matching engine 144 then passes the chatbot message to response generator 146, which generates an appropriate response.

In FIG. 1, in one embodiment, knowledge database 150 may receive and store input messages 210 and user-generated messages including the context for such messages, the messages being received via chatbot dialog interfaces 116 displayed on mobile device 112, laptop computing device 114 or desktop computing device 115. Many components of chatbot system 108 have been omitted to avoid unnecessarily complicating the description of the invention. One skilled in the art will realize that chatbot system 108 may comprise more or less components as needed to implement the present invention.

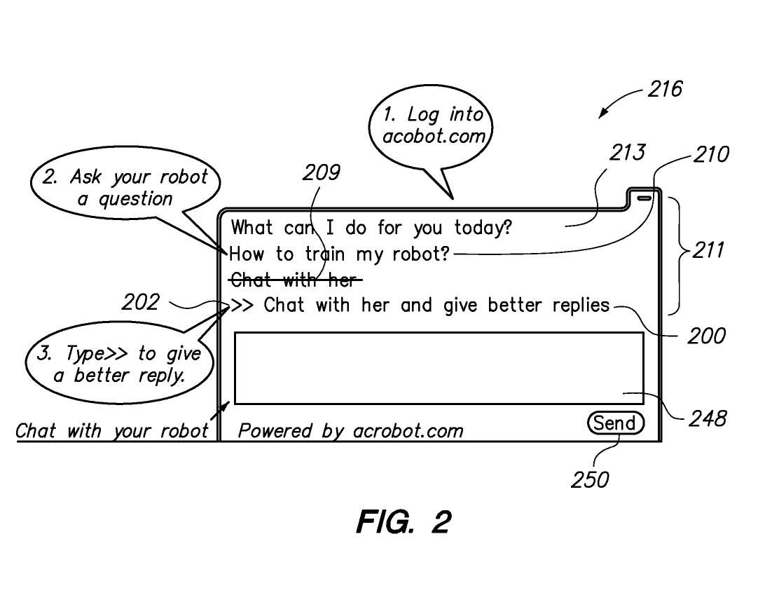

User-generated messages provide a context for subsequent chatbot messages of chatbot system 108, and for subsequent user input messages. In this manner, a new chatbot message is repetitively modified both prior to and during a chat session by entering a plurality of user-generated messages and training chatbot system 108 by preceding and/or following user-generated messages with unique identifiers (e.g., 202 of FIG. 2).

Briefly, in operation, merchant 106 trains chatbot system 108 to provide modified chatbot messages that are displayed by output display 109 of chatbot dialog interface 116. Merchant 106 utilizes merchant website 107 to install and utilize chatbot system 108. Merchant website 107 can provide a plethora of information to numerous customers simultaneously. Merchant website 107 operatively couples to Internet 101 via local network line 128.

Merchant 106 trains chatbot system 108 to provide modified chatbot messages 109 during a chat session. Thus, for example, merchant 106 might wish to teach chatbot system 108 to respond to address inquiries received from users of merchant website 107. User/merchant 106 begins by entering “Where are your offices?” into chatbot dialog interface 116.

In response, chatbot system 108 might generate a response such as “Please check our website, thank you.” Merchant 106 being dissatisfied with this message may wish to replace this chatbot response with the merchant's business address. Generally, merchant 106 can then enter “100 Main Street” into chatbot dialog interface 116. Thereafter, when the customer enters an input message “Where is your business located?,” chatbot system 108 replies, “100 Main Street”. Those skilled in the art will recognize that user-generated message (provided by merchant 106) is more robust and descriptive than the initial chatbot message.

FIG. 2 illustrates chatbot dialog interface 216 of chatbot system 108 (FIG. 1) in accordance with an exemplary embodiment of the present invention.

In FIG. 2, chatbot dialog interface 216 includes a visual graphic that encompasses two main areas namely dialog box 248 and output display 211. User input messages entered via dialog box 248 are displayed in output display 211. Chatbot response messages generated by chatbot system 108 are also displayed by output display 211.

Once chatbot system 108 is initialized, chatbot dialog interface 216 is displayed and is ready to initiate a chat session. Specifically, upon initiation, chatbot system 108 displays a prompt message “What can I do for you today?” 213 that prompts merchant 106 for an input message. “What can I do for you today?” 213 is a special output message, called an initial or opening message.

Responsive to prompt message “What can I do for you today?” 213, the user (e.g. merchant 106) enters an input message “How to train my robot?” 210 into dialog box 248 and then clicks send button 250. Chatbot system 108 responds by displaying output message “Chat with her” 209. Here, merchant 106 is dissatisfied with this message and wishes to train chatbot system 108 to display a modified message from the user.

Merchant 106 then enters user-generated message “Chat with her and give better replies” 200 into dialog box 248. This user-generated message 200 is preceded by a predetermined unique identifier such as the double angle brackets “>>” 202. Alternatively or in addition, the user-generated message 200 may be followed by the predetermined unique identifier. Those skilled in the art will realize that other identifier types e.g., asterisk, etc. can by utilized consistent with the spirit and scope of the present invention.

Predetermined unique identifier 202 directs chatbot system 108 to replace output message “Chat with her” 209 with user-generated message “Chat with her and give better replies” 200. As directed, chatbot system 108 responds to the predetermined unique identifier 202 and replaces output message “Chat with her” 209 with user-generated message “Chat with her and give better replies” 200 and then displays a crossed-out output message “Chat with her” 209 in output display 211 to indicate that message 209 is no longer valid.

Future input inquiries relating to “How to train my robot?” entered into dialog box 248 would generate the response “Chat with her and give better replies”. In this manner, merchant 106 can train chatbot system 108 to provide enhanced responses to input messages from user 102 or other customers. The back and forth interaction between chatbot system 108 and merchant 106 via chatbot dialog interface 216 allows knowledge database 150 (FIG. 1) to be modified based on myriad combinations of user-generated messages 200 as context for additional future chatbot messages.

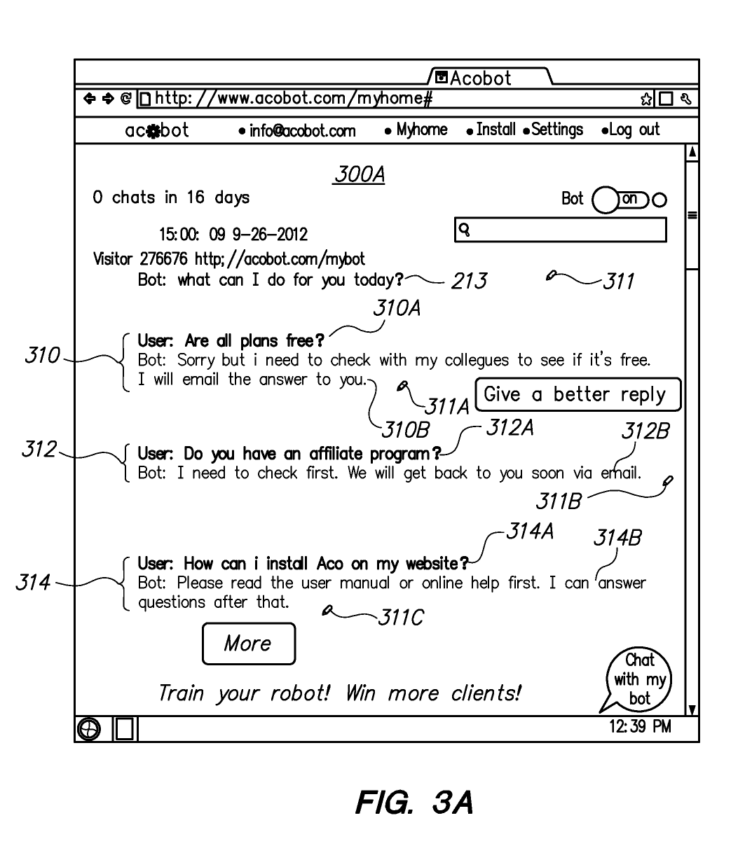

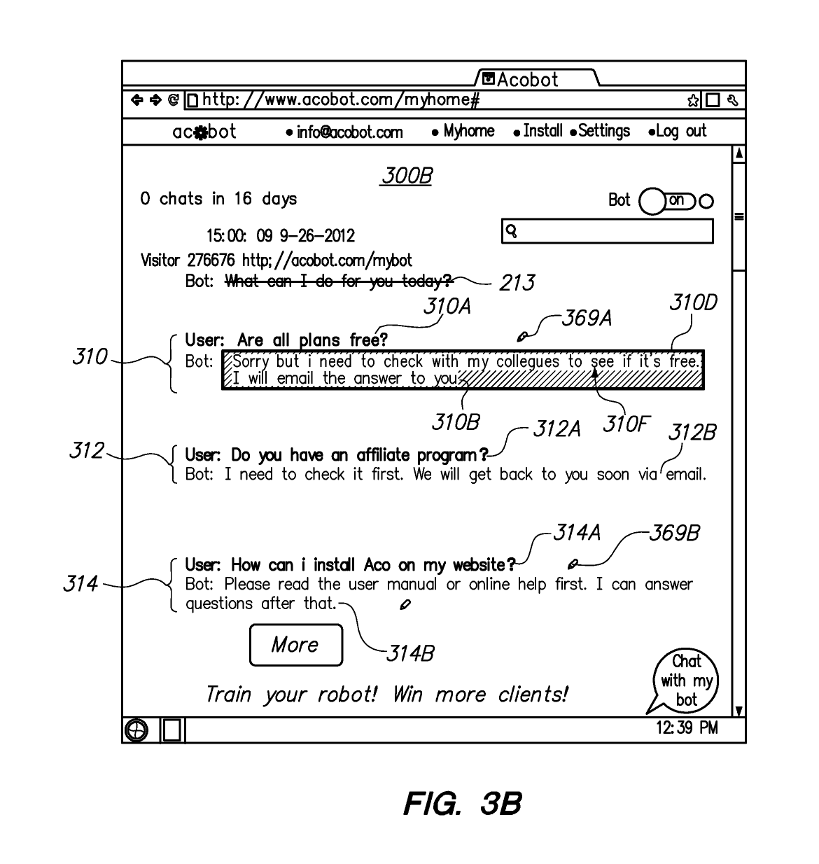

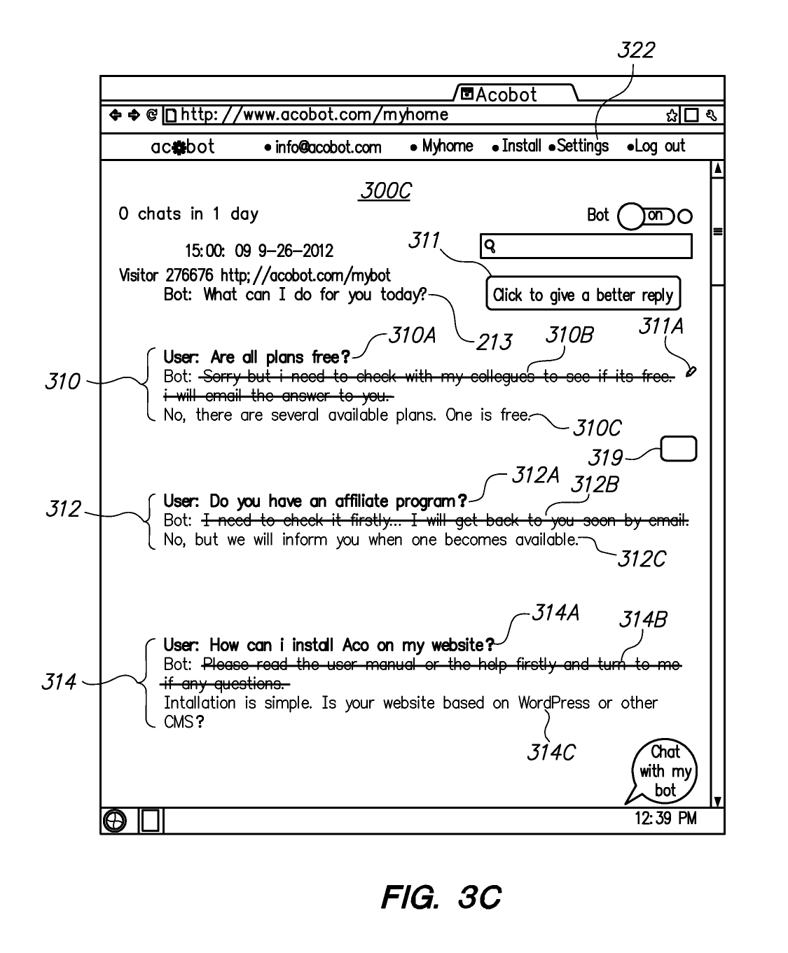

FIG. 3A illustrates chat log interface 300A according to an exemplary embodiment of the present invention.

In FIG. 3A, a user (e.g. merchant 106) can employ chat log interface 300A for training and entering better chatbot replies. Specifically, chat log interface 300A can enter better chatbot replies to input messages that are entered by a user during a prior chat session. The better chatbot replies, which are entered without leaving chat log interface 108A, can then update relevant entries in a knowledge database. In this manner, in an embodiment, chatbot system 108 of the present invention facilitates efficient and easy entry of better chatbot replies to respond to future user input messages.

Referring now to FIG. 3A, chat log interface 300A is displaying input and output messages 310, 312 and 314 as shown. Chat log interface 300A is also displaying edit links 311A, 311B and 311C for modifying output messages that respond to the input messages.

As a chat session proceeds, the user employs dialog box 248 (FIG. 2) to enter the input messages. In response, chatbot system 108 also uses dialog box 248 to display output messages responding to the input messages. The system then records all of the messages pertaining to the session for display via chat log interface 300A.

Upon user request, chat log interface 300A is displayed showing the recorded input and output messages for the chat session. Specifically, as shown, chat log interface 300A shows input message 310A and its corresponding response, output message 310B. Chat log interface 300A also displays other recorded messages namely input messages 312A and its corresponding response, output messages 312B, and input message 314A and its corresponding response output message 314B.

As shown, chat log interface 300A also shows edit link 311A for modifying output message 310B. Note that edit link 311A and output message 310B are adjacent since edit link 311A is used to provide a better chatbot reply for output message 310B. Other edit links are also provided to modify each output message. In one embodiment, the edit links are visible without a mouse-over event; for example, edit link 311B for modifying output message 312B, and edit link 311C for modifying output message 314B are shown. In an alternate embodiment, the user can mouse-over the relevant areas to display edit links 311A, 311B and 311C.

As shown in FIG. 3A, the initial input message entered by the user during a chat session is “Are all plans free?” 310A. Responsive thereof, chatbot system 108 displays output message “Sorry but I need to check with my colleagues to see if it is free. I will email the answer to you” 310B. The user then asks a follow up question: “Do you have an affiliate program?” 312A. In response, chatbot system 108 says “I need to check first. We will get back to you via email” 312B. The user then further inquires as to: “How can I install Aco on my website?” 314A. In response, chatbot system 108 directs the user as follows: “Please read the user manual or online help first, and contact me if any question” 314B. Operation of chat log interface 300A will now be described with reference to FIGS. 3A, 3B and FIG. 3C.

In operation, and with reference to FIGS. 3A and 3B, the user begins by displaying chat log interface 300A as shown in FIG. 3A. Next, the user may desire to modify output message “Sorry but I need to check with my colleagues to see if it's free. I will email the answer to you.” 310B to create a better reply for input message 310A. The user begins by selecting edit link 311A and upon selection, output message “Sorry but I need to check with my colleagues to see if it's free. I will email the answer to you.” 310B is highlighted (310F) and displayed within text box 310D of FIG. 3B.

FIG. 3B illustrates chat log interface 300B according to an exemplary embodiment of the present invention.

In FIG. 3B, after output message 310B is highlighted (310F) and displayed within text box 310D, the user can then type the new better reply within text box 310D. Upon typing, the new better reply replaces the highlighted output message 310B within text box 310D. That new better reply 310C is shown in FIG. 3C. Note also that chat log interface 300B shows edit links 369A for editing input message 310A and edit link 369B for editing input message 314A.

FIG. 3C illustrates chat log interface 300C according to an exemplary embodiment of the present invention.

In FIG. 3C, chat log interface 300C displays the new better replies and the prior input messages crossed out. In particular, when a new better reply 310C is typed and saved to replace output message 310B in FIG. 3B, chat log interface 300C displays the new better reply 310C as the response for input message 310A. The prior output message 310B is displayed as deleted. In one embodiment, the prior output message 310B is crossed out as here. In other embodiments, the prior output message 310B might be grayed out in any manner that indicates that the prior response is no longer applicable.

Note here that upon a user hover over better reply 310C, edit link 311A is again displayed given the user an opportunity to modify better reply 310C multiple times as desired by the user. Script link 319 is also displayed upon the user hover. Script link 319 displays the script associated with better reply 310C and the user can directly modify better reply 310C within the script.

In one embodiment, chat log interface 300C uses one or more scripts to accomplish updates of output messages 310C, 312C and 314C. As further discussed below, scripts are text files or database records that include chat session dialogue and instructions for chatbot system 108. A script typically consists of user messages responsive to the chatbot messages and chatbot messages responsive to the user messages.

Scripts can store and display context information and the relationship between the input and output messages in a compact yet intuitive manner; users can easily and efficiently use scripts to update a message without updating other messages that use the updated message as context. In one embodiment, the scripts are not a “knowledge base” that the chatbot engine can use directly. They are media that bridge front end (all training features) and the back end (the chatbot engine).

In FIG. 3C, note also that the user has entered better replies for the other input messages namely input message 312A and input message 314A. Thus, input message 312A has new better reply 312C, while the prior output message 312B is shown as deleted. Input message 314A has new better reply 314C while its prior output message 314B is shown as deleted. Consequently, the new better replies are used to modify corresponding knowledge entries in the knowledge database. In this manner, in an embodiment, chatbot system 108 of the present invention facilitates efficient and easy entry of better chatbot replies to respond to future user input messages.

Chat Log Training Via Scripts

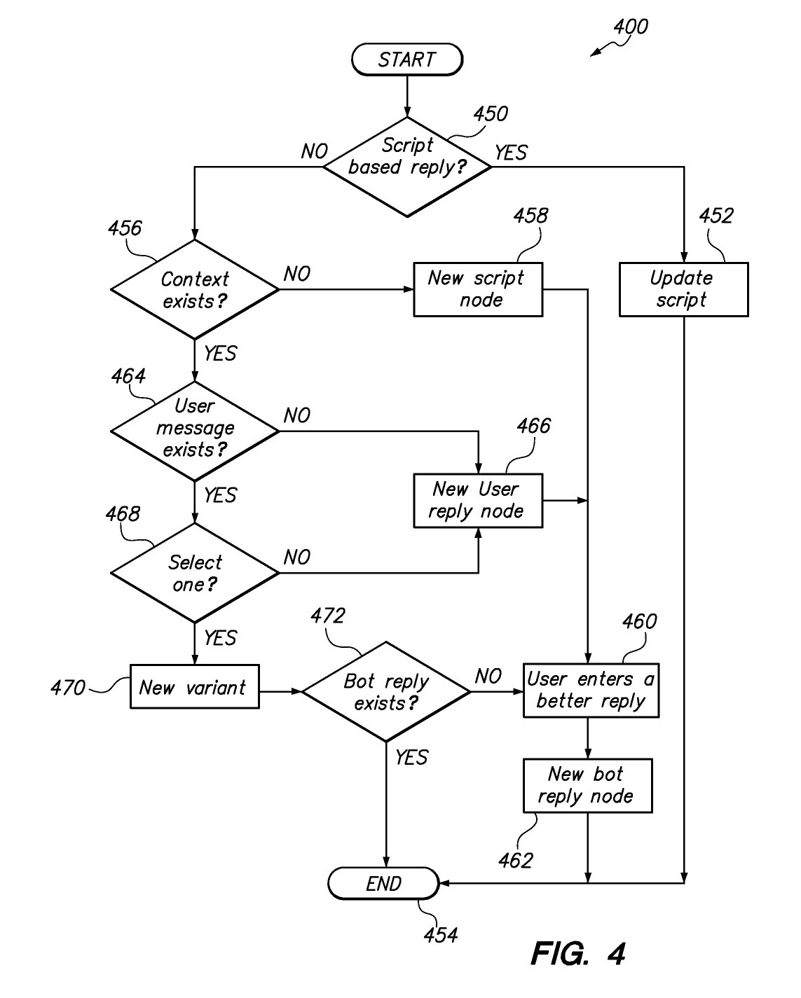

FIG. 4 illustrates better reply method 300D for creating or updating a script in accordance with an exemplary embodiment of the present invention.

In FIG. 4, the user initiates better reply method 400 to create or update a script when the user selects edit link 311A (FIG. 3A) to enter a better reply for output message 310B.

At decision block 450, upon the user selecting edit link 311A, chatbot system 108 determines whether output message 310B is provided by an existing script. That is, it is determined whether output message 310B is based on an existing script. If no, execution proceeds to block 456. Else, execution proceeds to block 452.

At block 452, it has been determined that output message 310B is based on an existing script. Thus, the existing script is updated with a new better reply 310C (FIG. 3C), after which method 300D is terminated at 354.

At decision block 456, output message 310B is not based on an existing script, thus chatbot system 108 determines whether a context exists for output message 310B. Specifically, chatbot system 108 determines if the context (“Bot message 1”) of output message 310B matches an existing Bot reply (field_message) in Script nodes). In one embodiment, during chatting, the matching algorithm employed can identify context during processing of the input message. This typically involves normalization and pattern/keyword based matching. Here, if the context exists, execution proceeds to decision block 464. Else, execution proceeds to block 458.

At block 458, At block 458, the context of output message 310B is not found in Scripts, thus, chatbot system 108 creates a new Script root node. The new Script node has at least two fields. The first field namely field_message=“User message 1” and the second field, field_context=“Bot message 1.” Execution then proceeds to block 460.

At block 460, the user employs chat log interface 300A to enter new better reply 310C. Execution then proceeds to block 462.

At block 462, chatbot system 108 then creates a new Bot reply node. Execution subsequently ends at 454.

At decision block 464, it has been determined that a context exists for output message 310B. Thus, chatbot system 108 next determines whether there is one or more existing User replies with the same context as output message 310B. If yes, execution proceeds to decision block 468, else execution proceeds to block 466.

At block 466, no existing User reply has the same context as output message 310B. Thus, chatbot system 108 determines whether the matched context includes a Bot reply. If yes, chatbot system 108 adds the User reply as a new child node of the matched Bot reply node (context) to the Script. Note that if chatbot system 108 finds one Bot reply as matched context, the new User reply is added as the child of the Bot reply. If chatbot system 108 finds two or more Bot replies as matched context, the system selects one as the parent of the new User reply. In one implementation, chatbot system 108 selects one with the least children (User replies following it).

At decision block 468, one or more existing User replies have the same context as output message 310B. Chatbot system 108 displays all User replies with the matched context. The user can then determine whether the user reply to be added means the same as any of the above user replies. If yes, user chooses one and execution proceeds to block 470. If no, execution proceeds to block 466 as previously described above.

At block 470, chatbot system 108 adds the selected User reply as a new variant to the existing User reply. Execution then proceeds to decision block 472.

At decision block 472, it is determined whether a Bot reply exists for the above User reply. If no, execution proceeds to block 460 and block 462. Otherwise, execution terminates at 454.

In summary, as discussed with reference to FIGS. 3A-3C and FIG. 4, when reviewing a chat log, and the user is unsatisfied with one or more output messages such as output message 310B given by the chatbot system 108, the user can select the unsatisfying output message and the select edit link 311A to enter a better reply. Chatbot system 108 marks the old reply as deleted and also displays the new better reply adjacent to it. The system determines whether the reply is given by script; if yes, the system updates the corresponding output message node; otherwise, the system creates a new script or adds new nodes to existing scripts based on whether the context and user reply with the same meaning exist or not. Thus, in one embodiment, the present invention can use a chat log interface to modify entries and automatically create scripts allowing the user to modify input/output messages with context.

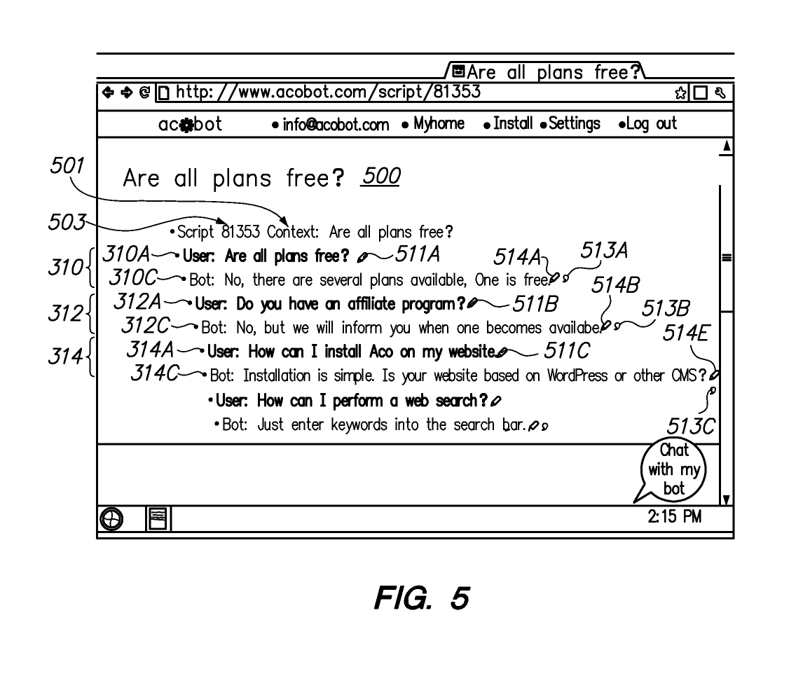

FIG. 5 illustrates script interface “Are all plans free?” 500 in accordance with an exemplary embodiment of the present invention.

In FIG. 5, script interface “Are all plans free?” 500 displays a script and its stored input/output messages 310, 312, 314 in a tree format. As shown, the first context 501 is “Are all plans free?” which is based on input message “Are all plans free” 310A. Unlike conventional systems, the present invention displays input/output messages and their context in a tree format that can be viewed by users in an intuitive manner and enables users to easily modify entries. Input/output messages are modifiable using this script, and when a message is modified, there is no need to update other entries that use the modified message as context.

In FIG. 5, script interface “Are all plans free?” 500 can be accessed by selecting view thread icon not shown. Upon selection, the input/output messages 310, 312 and 314 are displayed in a tree format. Note that this script can be manually created by a user or can be automatically generated by the system using a edit link 311A, 311B, etc. of chat log 300A of FIG. 3A.

As seen, the script identifier is 81353 along with first context “Are all plans free?” 310 as shown. As used herein, context refers to a previous input or output message or knowledge entry that gives meaning to a current input or output message or knowledge entry. For example, in the following chat session: the context for the user input message “Yes,” is “Are you a girl?”.

User: Are you a female bot?

Bot: Yes. Are you a girl?

User: Yes

Bot: How do you feel being a girl?

In FIG. 5, input message “Are all plans free?” 310A is the first context in a dialogue sequence between the user and chatbot system 108. Script 404 is assigned to this context using the identifier 81353. As can be seen, all of the input/output messages are then displayed in a tree format for easy viewing by the user. This tree format is shown in FIG. 5.

Input message 310A is first shown as a parent or root entry, which is the first entry that has no other references. Next, output message 310C is a child of input message 310A and is shown indented below input message 310A. The user enters this output message and the system saves it as a database record with the following additional data: the unique identifier (not shown) of output message 310C and the parent identifier (81353) of the input it replies to namely input message 310A.

Next, input message 312A is a child of output message 310C and is subsequently indented below output message 310C. The user enters input message 312A and the systems creates a database record with the following additional data: the unique identifier of input message 312A, the parent identifier of output message 310C, which input message 312A is replying to, and the context identifier of the previous output message 310C.

This process is repeated for subsequent messages, with unique identifiers being assigned for the current message, a parent identifier and a context identifier. Thus, in FIG. 5, output message 312C is a child of input message 312A. Input message 314A is a child of output message 312C, and finally, output message 314C is a child of input message 314A. Therefore, all subsequent input/output messages under “Are all plans free? 310 are displayed in a tree format based on identifier 503.

Users can enter input/output messages as desired. As the context information and relationship between the messages are kept and displayed in a compact yet intuitive manner, users can easily and efficient work with the scripts, without worrying about the inconsistency. When users want to add a new input when there is no existing output message, they create another new script. When users delete an input or output message from the script, system deletes all of its children and children of children, or asks users whether they want to move the children as the new children of other messages or to a new script.

The subsequent input/output messages 312, 314 are displayed as children of input/output message 310. Thus, chatbot system 108 displays input/output messages in an intuitive manner where child entries that use parent entries as context can easily be seen, thus establishing a direct relationship between the child entries and parent entries.

As further illustration, consider the following chat session between a user and chatbot system 108 (Chatbot).

User (Message 1): Are you a female bot?

Chatbot (Message 2, a child of Message 1): Yes. Are you a girl?

User (Message 3, a child of Message 2): Yes.

Chatbot (Message 4, a child of Message 3): How do you feel being a girl?

An embodiment of the present invention provides a structure that contains all information that the traditional structure contains. A traditional structure, as discussed previously in the background of the present application, would contain two separate entries. Unlike such traditional systems, one embodiment is a single tree format; however, this tree format can generate two input/output messages in traditional format. This single tree format also contains additional information that the traditional method does not.

Unlike a traditional system that uses two entries, the message “Are you a girl?” appears only once in the above data structure. It serves as the reply to the previous user message and the context for the next user message. Thus, when a user such as merchant 106 or an administrator edits this message, the reply and context are updated at the same time, and thus, consistency is maintained. For example, where “girl” is updated as “female, it looks like:

User (Message 1): Are you a female bot?

Chatbot (Message 2, a child of Message 1): Yes. Are you a female?

User (Message 3, a child of Message 2): Yes.

Chatbot (Message 4, a child of Message 3): How do you feel being a girl?

Unlike traditional systems, the chatbot system 108 responds without any problem. The benefits of the present invention can be seen with the following additional examples: In the above example, the user would answer either “Yes” or “No” to the question posed by chatbot system 108. Chatbot input/output messages replying to either question respectively are entered. In traditional systems, the knowledge entry looks like:

Entry 1

User: Are you a female bot?

Chatbot: Yes. Are you a female?

Entry 2

User: Yes

Context: Are you a girl?

Chatbot: How do you feel being a girl?

Entry 3

User: No

Context: Are you a girl?

Chatbot: How do you feel being a boy?

As the number of entries grows, it gets more and more difficult for an administrator to understand and maintain the knowledge base. An embodiment of the present invention, on the other hand, generates the following tree format with child nodes indented. An administrator can easily work with the knowledge data even where there are many branches in the dialog.

User (message 1): Are you a female bot?

Chatbot (message 2, child of message 1): Yes. Are you a female?

_User (message 3, child of message 2): Yes.

_Chatbot (message 4, child of message 3): How do you feel being a girl?

_User (message 5, child of message 2): No.

_Chatbot (message 6, child of message 5): How do you feel being a boy?

Referring now to FIG. 5, each input message of input/output messages 310, 312 and 314 has a corresponding edit icon for making edits to that input message. Thus, input message 310A has adjacent edit icon 511A. When selected, edit icon 511A displays a script interface (not shown) that allows a user to modify input message 310A.

Similarly, input message 312A has adjacent edit icon 511B. When selected, edit icon 511B displays a script interface (not shown) that allows a user to modify input message 312A. Similarly, input message 314A has adjacent edit icon 511C. When selected, edit icon 511C displays a script interface (not shown) that allows a user to modify input message 314A. In FIG. 5, reply links 513A, 513B and 513C for generating replies to output messages 310C, 312C and 314C, respectively, are also shown.

Chat Log Generation: In one implementation, chat logs are organized by session in order to present the conversations in a meaningful and intuitive manner. A chat session is defined as a sequence of messages from a unique client that expires after a given period. Although this period can vary, a typical duration is 30 minutes, which is the typical duration for a website visit.

A chat session is initialized when user 102 enters a first message. During the chat session, chat history namely three previous pairs of input/output messages are display while the user visits other web pages. If user 102 remains inactive for over 30 minutes, the chat session expires. If user 102 visits a different web page when the session expires, chatbot system 108 clears the chat history in the chat box and displays the initial message (“What can I do for you today?”) as if the user were new. When displaying chat logs, chatbot system 108 organizes all messages by session (typically a session ID). Then the system sorts all sessions based on start time, that is, when the initial message from user 102 is received. Messages in each session are then sorted by their creation time.

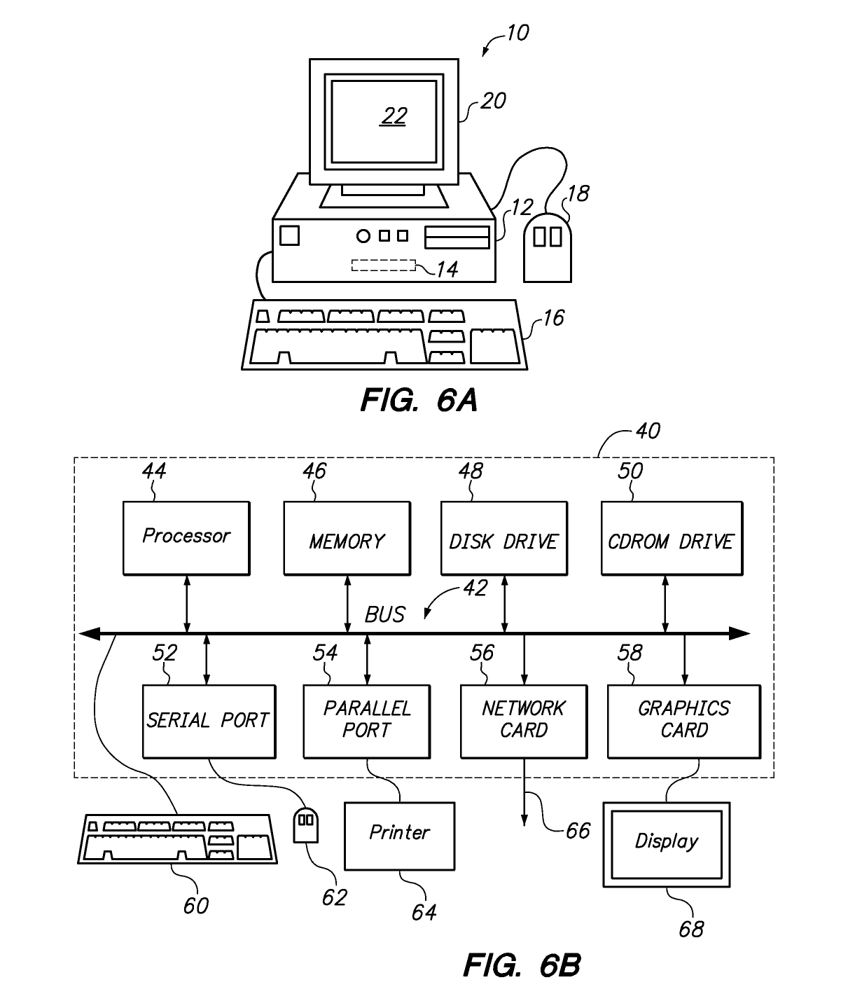

FIG. 6A shows a typical computer 10 such as would be operated by a user on the Internet and suitably programmed using one or more lines of code to execute embodiments of the present invention. Computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may other components in addition to those shown in FIG. 6A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 6A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 6A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 6B shows subsystems of the computer of FIG. 6A. In FIG. 6B, subsystems within box 40 are internal to, for example, the cabinet 12 of FIG. 6A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 6B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. As an example, embodiments of the present invention create one node for an input message and another node for an output message. In an alternative embodiment, a single node for a pair of input message and output message can be utilized. Thus, the above description should not be taken as limiting the scope of the invention, which is defined by the appended claims along with their full scope of equivalents.

I claim:

1. A method, operable by a chatbot, for updating chatbot output messages and corresponding entries in a knowledge database, wherein the chatbot includes a processor, an interactive dialog interface and said knowledge database, the chatbot receiving a plurality of input messages from a user and generating a plurality of output messages responsive to the plurality of input messages, the method comprising:
upon user request, displaying a chat log page in which said plurality of output messages are configured to be selectable by displaying adjacent to each one of said plurality of output messages an edit link associated with each one of said plurality of output messages; and
using the chat log page to modify a selected one of said plurality of output messages without leaving the chat log page, by highlighting the selected one of said plurality of output messages upon user selection of said edit link associated with said selected one of said plurality of output messages, and using a new output message entered by a user to replace the selected one of said plurality of output messages that is highlighted.

2. The method of claim 1 wherein said selected one of said plurality of output messages that is highlighted is displayed within a text box.

3. The method of claim 1 further comprising
upon replacing the selected one of said plurality of output messages with the new output message, crossing off the selected one of said plurality of output messages and displaying the crossed-off selected one of said plurality of output messages on the chat log page.

4. The method of claim 3 further comprising
displaying the new output message adjacent to said crossed off selected one of said plurality of output messages such that a user can determine that the new output message is the current output message of the chatbot to a corresponding user input message.

5. The method of claim 1 further comprising
using the chat log page to generating a script configured to display the new output message and its associated input message in a tree format.

6. The method of claim 1 further comprising
using the chat log page to update an existing script configured to display the new output message and its associated input message in a tree format.

7. A method, operable by a chatbot, for updating chatbot messages, wherein the chatbot includes a processor, an interactive dialog interface and a knowledge database, the chatbot processing a plurality of chatbot messages including one or more of a plurality of input and output messages, the method comprising:
upon user request, displaying a chat log page in which said plurality of chatbot messages are configured to be selectable; and
upon indication of a user to select any one of said plurality of chatbot messages, using the chat log page to modify, without leaving said chat log page, the selected one of said plurality of chatbot messages into a new output message as desired by a user.

8. The method of claim 7 wherein said plurality of chatbot messages are configurable by displaying an edit link associated with each one of said plurality of chatbot messages, said edit link configured to select the chatbot message associated with said edit link.

9. The method of claim 8 wherein said using the chat log page to modify the selected one of said plurality of chatbot messages further comprises highlighting the selected one of said plurality of chatbot messages upon user selection of said edit link associated with the selected one of said plurality of chatbot messages.

10. The method of claim 7 wherein the chat log page is used to modify the selected one of said plurality of chatbot messages by replacing the selected one of said plurality of chatbot messages with the new output message, crossing off the selected one of said plurality of chatbot messages and displaying the crossed-off selected one of said plurality of chatbot messages on the chat log page.

11. The method of claim 7 further comprising
displaying the new output message adjacent to said crossed off selected one of said plurality chatbot messages such that a user can determine that the new output message is the current output message for a corresponding user input message.

12. The method of claim 7 further comprising
using the chat log page to generating a script configured to display the new output message and its associated input message in a tree format.

13. The method of claim 7 further comprising
using the chat log page to update an existing script configured to display the new output message and its associated input message in a tree format.

14. A computer program product including a computer readable storage medium and including computer executable code for a chatbot, the computer executable code being executed by a processor, the computer program product comprising:
one or more code instructions displaying a chat log page in which said plurality of chatbot messages are configured to be selectable; and
one or more code instructions, upon indication of a user to select any one of said plurality of chatbot messages, using the chat log page to modify, without leaving said chat log page, the selected one of said plurality of chatbot messages into a new output message as desired by a user.

15. The computer product program of claim 14 wherein said plurality of chatbot messages are configurable by displaying an edit link associated with each one of said plurality of chatbot messages, said edit link configured to select the chatbot message associated with said edit link.

16. The method of claim 15 wherein using the chat log page to modify the selected one of said plurality of chatbot messages further comprises highlighting the selected one of said plurality of chatbot messages upon user selection of said edit link associated with the selected one of said plurality of chatbot messages.

17. The method of claim 14 wherein the chat log page is used to modify the selected one of said plurality of chatbot messages by replacing the selected one of said plurality of chatbot messages with the new output message, crossing off the selected one of said plurality of chatbot messages and displaying the crossed-off selected one of said plurality of chatbot messages on the chat log page.

18. The method of claim 14 further comprising
one or more code instructions displaying the new output message adjacent to said crossed off selected one of said plurality chatbot messages such that a user can determine that the new output message is the current output message for a corresponding user input message.

19. The method of claim 14 further comprising
one or more code instructions using the chat log page to generating a script configured to display the new output message and its associated input message in a tree format.

20. The method of claim 14 further comprising
one or more code instructions using the chat log page to update an existing script configured to display the new output message and its associated input message in a tree format.
